(19) United States
(12) Patent Application Publication
(10) Pub. No.: US 2004/0062991 A1
(43) Pub. Date: Apr. 1, 2004

(54) Negative electrode for lithium secondary battery, method for preparing negative electrode for lithium secondary battery and lithium secondary battery

(76) Inventors: Atsushi Fukui, Kobe-city (JP); Yasuyuki Kusumoto, Kobe-city (JP); Mariko Torimae, Kobe-city (JP); Hisaki Tarui, Kobe-city (JP)

Correspondence Address: KUBOVCIK & KUBOVCIK, SUITE 710, 900 17TH STREET NW, WASHINGTON, DC, 20006

(21) Appl. No.: 10/673,348

(22) Filed: Sep. 30, 2003

(30) Foreign Application Priority Data
Sep. 30, 2002 (JP) 2002-285742

(51) Int. Cl. H01M 4/58; H01M 4/66; H01M 4/62; B05D 3/02

(52) U.S. Cl. 429/218.1; 429/231.95; 429/245; 429/217; 427/201; 427/397.7

(57) ABSTRACT

A negative electrode for a lithium secondary battery obtained by sintering an active material layer on a current collector under a non-oxidizing atmosphere after the active material layer including primary particles of an active material containing silicon and/or a silicon alloy and a binder is formed on an electrically conductive metal foil as a current collector. A mean diameter of primary particles of the active material is less than 1 μm, the primary particles are dispersed uniformly in the active material layer, and the primary particles and the binder are uniformly mixed and distributed.

### FIELD OF THE INVENTION

The present invention relates to a negative electrode for a lithium secondary battery, a method for preparing the negative electrode and a lithium secondary battery including the negative electrode.

### BACKGROUND OF THE INVENTION

A lithium secondary battery that comprises a nonaqueous electrolyte and utilizes the transfer of lithium ions between a positive electrode and a negative electrode for charge and discharge of the battery has recently been used as one of new type high output and high energy density batteries.

A negative electrode for a lithium secondary battery in which an active material including silicon contained in a binder is adhered on a current collector having an average surface roughness of not less than 0.03 μm has been proposed (Japanese Patent Laid-open NO. 2000-12088).

However, it is known that an active material including silicon increases and decreases in volume when lithium ions are occluded and released, and the active material is pulverized during charge and discharge cycles and separates from the current collector. This causes deterioration of current collecting characteristics (current collectability) and of charge and discharge cycle characteristics.

### OBJECT OF THE INVENTION

An object of the present invention is to enhance the internal strength of an electrode and to improve current collectability to provide a negative electrode for a lithium secondary battery having excellent charge and discharge cycle characteristics, a method of preparing the negative electrode and a lithium secondary battery including the negative electrode.

### SUMMARY OF THE INVENTION

A negative electrode for a lithium secondary battery of the present invention is obtained by sintering an active material layer on a current collector under a non-oxidizing atmosphere after the active material layer comprising primary particles of an active material including silicon and/or silicon alloy and a binder is formed on an electrically conductive metal foil as a current collector. A mean diameter of primary particles of the active material is less than 1 μm, the primary particles are dispersed uniformly in the active material layer, and the primary particles and the binder are uniformly mixed and distributed.

### BRIEF DESCRIPTION OF THE DRAWINGS

FIG. 1 is a cross section of the batteries prepared in the Experiments.

FIG. 2 is a photograph showing a section of the active material layer of the negative electrode of battery A1.

FIG. 3. is a photograph showing a section of the active material layer of the negative electrode of battery B2.

[Explanation of elements]

| | |
|---|---|
| 1: | positive electrode |
| 2: | negative electrode |
| 3: | separator |
| 4: | positive electrode can |
| 5: | negative electrode can |
| 6: | positive electrode current collector |
| 7: | negative electrode current collector |
| 8: | insulation packing |

### DETAILED EXPLANATION OF THE INVENTION

In the present invention an active material having a mean diameter of primary particles of an active material of less than 1 μm is uniformly dispersed in an active material layer. A binder is also evenly distributed around the fine primary particles of the active material. Therefore, even if the active material expands or reduces its volume during charge and discharge reactions as a result of occluding and releasing lithium, the binder is unlikely to be decomposed and the internal strength of the electrode and current collectability can be improved. As a result charge and discharge cycle characteristics can be improved.

If a mean diameter of the primary particles is greater than 1 μm, the advantages of the present invention cannot be obtained. I.e., the charge and discharge cycle characteristics cannot be sufficiently improved. If the mean diameter of the primary particles is too small, handling is difficult. Therefore, the mean diameter of the primary particles is preferably at least 0.1 μm.

The method of the present invention provides a method for preparing the negative electrode of a lithium secondary battery of the present invention. The method includes a step of preparing a slurry in which an active material is contained in a binder solution, a step of applying the slurry onto a current collector of an electrically-conductive metal foil, and a step of sintering the active material layer formed on the current collector under a non-oxidizing atmosphere. The active material is silicon and/or silicon alloy having a mean diameter of primary particles of less than 1 μm. The active material is included in the binder solution in the form of primary particles.

The active material layer in which primary particles are uniformly dispersed can be formed by breaking apart (e.g., crushing or disintegrating) the active material to form a condition of primary particles in the binder solution. A condition of primary particles means that a structure of secondary particles in which primary particles are aggregated is destroyed and primary particles are dispersed. The secondary particles are broken apart to form primary particles before they are added to the binder solution or the secondary particles are broken apart to form primary particles in the binder solution.

When the secondary particles are broken apart to form primary particles before they are added to the binder solution, a mortar, a roll mill, a sand mill, a ball mill, an attritor, and the like can be used.

When the secondary particles are broken apart to form primary particles in the binder solution, the binder solution containing the active material can be stirred and dispersed by a agitator or a disperser, for example, a mortar, a mixer, a homogenizer, a dissolver, a kneader, a roll mill, a sand mill, a ball mill, and the like.

It is preferred not to apply energy such that the primary particles are destroyed when the secondary particles are broken apart. It is preferable that the particle size distribution of the primary particles is as narrow as possible. If the particle size distribution is broad, absolute volume changes are varied among the primary particles with large size differences during occluding and releasing of lithium. Therefore, the active material layer easily distorts, and the binder is easily destroyed to deteriorate current collectability in the electrode.

The mean diameter of the particles of the active material and the particle size distribution can be measured by a particle distribution analyzer using laser diffraction or the like. A particle distribution analyzer using laser diffraction was used in the experiments.

The surface of the current collector onto which the active material layer is provided preferably has a surface roughness (Ra) of at least 0.2 μm. A current collector having such surface roughness can provide a sufficient contact area for the active material layer and the current collector to improve the adhesion of the active material layer and the current collector. A reduction of the current collectability of the electrode can be further inhibited. When the active material layers are provided on both surfaces of the current collector, both surfaces preferably have a surface roughness of at least 0.2 μm.

The surface roughness (Ra) and the average distance (S) between adjacent local peaks preferably satisfy the relationship 100 Ra≧S. The surface roughness (Ra) and the average distance (S) between adjacent local peaks are defined in the Japanese Industrial Standards (JIS B 0601-1994), and can be measured by a surface roughness tester.

A current collector treated to have a roughened surface can be used in the electrode of the present invention. As a method of roughening the surface, plating, vapor deposition, etching, polishing and the like can be illustrated. Plating and vapor deposition are methods for forming an uneven layer on the surface of the current collector. Plating can be electrolytic or non-electrolytic. As vapor deposition, there can be illustrated sputtering, chemical vapor deposition (CVD), evaporation, and the like. As etching, physical or chemical etching can be used. As polishing, there can be illustrated polishing with sand paper, blasting, and the like.

There are no limitations regarding the current collector if the current collector comprises an electrically conductive metal foil. As examples of the current collector, a conductive metal foil composed of a metal such as copper, nickel, iron, titanium, cobalt and the like, and an alloy containing any combination thereof can be illustrated. The current collector preferably contains a metal element that easily diffuses into the particles of the active material. From this point of view, a metal foil containing copper, especially, a copper metal foil and a copper alloy foil are more preferred. A copper element when heat treated easily diffuses into silicon. Therefore, when the negative electrode is sintered, adhesion of the current collector and active material layer can be expected to be improved.

It is also possible to use a metal foil having a layer containing copper on a surface as the current collector. That is, a copper or copper alloy layer provided on the surface of a metal foil which does not include copper can be used. The metal foil having a layer containing copper can be prepared by electrolytic plating. Concretely, a nickel foil plated with copper or a copper alloy can be illustrated.

There is no limitation with respect to the thickness of the current collector (Y). However, a thickness of 10˜100 μm is preferable. There is no limitation regarding the upper limit of the surface roughness (Ra) of the surface of the current collector. However, the upper limit is preferably not greater than 10 μm because the thickness of the current collector (Y) is preferably in a range of 10˜100 μm.

The thickness (X) of the active material layer preferably satisfies relationships with the thickness (Y) of the current collector and the surface roughness (Ra) of the current collector of 5Y≧X, and 250 Ra≧X. If such relationships are satisfied, deformation, for example, wrinkles, and the like, of the current collector can be prevented, and the active material layer can be prevented from peeling from the current collector.

There are no limitations with respect to the thickness of the active material layer (X). A thickness of not greater than 1000 μm is preferred, and a thickness of 10˜100 μm is more preferred. A negative electrode for a lithium secondary battery of the present invention is obtained by sintering under a non-oxidizing atmosphere after the active material layer is provided on the surface of the current collector. Sintering under a non-oxidizing atmosphere can be performed under, for example, a nitrogen atmosphere, an inactive gas atmosphere (for example, argon or the like), and the like. It is also possible to perform the sintering under a reduction atmosphere, for example, a hydrogen atmosphere, or the like. The temperature used for the sintering is preferably lower than the melting point of the current collector and of the particles of the active material. For example, when a copper foil is used as the current collector, it is preferred that the sintering temperature is not greater than the melting point of copper, i.e., 1083° C. The temperature used for sintering is preferably in a range of 200˜500° C., and more preferably, in a range of 300˜450° C. As a method of sintering, spark plasma sintering, hot pressing, or the like, can be used.

In the present invention, preferably after the active material layer is provided on the current collector and prior to sintering, the active material layer with the underlying current collector is subject to rolling. Rolling can increase packing density in the active material layer and adhesion between particles of the active material and between the active material and the current collector to improve charge and discharge cycle characteristics.

The binder used in the present invention preferably does not completely decompose after the heat treatment for sintering. If the binder remains after the heat treatment and is not decomposed, the binding ability of the binder increases adhesion between particles of the active material and between the active material and the current collector, as well as sintering. If an electrically conductive metal foil having a surface roughness (Ra) of at least 0.2 μm is used as the current collector, the binder penetrates into the uneven surface of the current collector, and an anchor effect occurs between the binder and the current collector to increase the adhesion. Even if the volume of the particles of the active material increases or decreases during occluding and releasing of lithium ions, peeling of the active material layer from the current collector can be prevented and excellent charge and discharge cycle characteristics can be obtained.

As the binder, polyimide is preferred. Thermoplastic and thermosetting polyimides can be illustrated as the polyimide. Polyimide can be obtained by heat treatment of polyamic acid.

Polyimide is obtained by heat treatment of polyamic acid by dehydration condensation to form polyimide. A yield of imide of the polyimide is preferably at least 80%. The yield of imide means the mol % of the produced polyimide to the polyimide precursor (polyamic acid). Polyimide having an imide yield of at least 80% can be obtained when polyamic acid in N-methyl-2-pyrrolidone (NMP) is heated at 100˜400° C. for not less than one hour. If the temperature is 350° C., the imide yield is 80% for about a one hour heat treatment, and is 100% for about a three hour heat treatment.

It is preferred in this invention that the binder is not completely decomposed after heat treatment for sintering. Therefore, if polyimide is used as the binder, it is preferred that the heat treatment for sintering is done at a temperature of not greater than 600° C., which does not cause complete decomposition of polyimide.

An amount of the binder in the active material layer is preferably at least 5% based on the total weight of the active material layer. A volume of the binder is preferably at least 5% of the total volume of the active material layer. If the amount of the binder in the active material layer is too little, the binder may not be able to provide sufficient adhesion in the electrode. If the amount of the binder in the active material layer is excessive, resistance in the electrode increases to make the initial charge difficult. Therefore, the amount of the binder in the active material layer is preferably not greater than 50 weight % of the total weight of the layer, and the volume of the binder in the active material layer is preferably not greater than 50% of the total volume of the layer.

An electrically conductive powder can be mixed in the active material layer. If an electrically conductive powder is mixed in the layer, an electrically conductive network is formed around the particles of the active material to increase current collectability of the electrode. As the electrically conductive powder, materials similar to the electrically conductive metal foil can preferably be used. Concretely, copper, nickel, iron, titanium, cobalt and the like, and an alloy or a mixture of these elements can preferably be used alone or in combination thereof. Copper powder is preferable as a metal powder. An electrically conductive carbon powder can also preferably be used.

An amount of the electrically conductive powder is preferably not greater than 50 weight % of the total weight of the electrically conductive powder and the particles of the active material. If an amount of the electrically conductive powder is excessive, the ratio of the particles of the active material becomes relatively low, and charge and discharge capacity of the electrode is reduced.

As the particles of the active material, particles of silicon and/or silicon alloy can be illustrated. As the silicon alloy, a solid solution of silicon and at least one additional element, an intermetallic compound of silicon and at least one additional element, an eutectic alloy of silicon and at least one additional element, and the like can be illustrated. The alloy can be prepared by arc melting, liquid quenching, mechanical alloying, sputtering, chemical vapor deposition, calcining, or the like. As liquid quench, single roll quenching, double roll quenching, atomizing, for example, gas atomizing, water atomizing, disc atomizing, and the like, can be illustrated.

As the particles of the active material, silicon and/or silicon alloy particles coated with a metal or the like can also be used. The particles can be coated by electroless plating, electrolytic plating, chemical reduction, vapor deposition, sputtering, chemical vapor deposition, or the like. As the metal used to coat the surface of the particles, it is preferred to use the same metal as used for the electrically conductive metal foil. If the particles are coated with the same metal as the metal foil, the degree of bonding with the current collector dramatically improves by sintering, and excellent charge and discharge cycle characteristics can be obtained.

The particles of the active material may include particles comprising a material which forms an alloy with lithium. As such material, germanium, tin, lead, zinc, magnesium, sodium, aluminum, gallium, indium, and an alloy thereof can be illustrated.

The lithium secondary battery of the present invention contains the negative electrode described above, a positive electrode containing a positive electrode active material and a non-aqueous electrolyte.

There is no limitation with respect to the solvent to be used for the nonaqueous electrolyte. Cyclic carbonates, for example, ethylene carbonate, propylene carbonate, butylene carbonate, and the like; chain carbonates, for example, dimethyl carbonate, methylethyl carbonate, diethyl carbonate, and the like, can be used alone or in combinations thereof. A mixture of the cyclic carbonate described above and an ether, for example, 1,2-dimethoxyethane, 1,2-diethoxyethane, and the like, can also be used.

As a solute to be dissolved in the nonaqueous electrolyte, LiPF₆, LiBF₄, LiCF₃SO₃, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and the like, can be used alone or in various combinations thereof. A mixture of LiXF_{y} (where X is P, As, Sb, B, Bi, Al, Ga or In; when X is P, As or Sb, y is 6; and when X is B, Bi, Al, Ga or In, y is 4) and lithium perfluoroalkylsulfonylimide, LiN(CₘF₂ₘ₊₁SO₂) (CₙF₂ₙ₊₁SO₂) (where m and n are each independently an integer of 1˜4), or lithium perfluoroalkylsulfonylmethide, LiC(CₚF₂ₚ₊₁SO₂) (C_{q}F_{2q+1}SO₂) (CᵣF₂ᵣ₊₁SO₂) (where p, q and r are each independently an integer of 1˜4) can preferably be used. Especially, a mixture of LiPF₆ and LiN(C₂F₅SO₂)₂ is preferred.

As the electrolyte, a gel polymer electrolyte in which the electrolyte is impregnated in a polymer, for example, polyethylene oxide, polyacrylonitrile, and the like, and an inorganic solid electrolyte, for example, LiI, Li₃N, and the like, can also be used. There is no limitation regarding the electrolyte for the present invention as long as the lithium compound as the solute which provides ion conductivity and the solvent in which the lithium compound is dissolved do not decompose during discharge, charge or storage of the battery.

As the positive electrode active material for the lithum secondary battery, lithium-containing transition metal oxides, for example, LiCoO₂, LiNiO₂, LiMn₂O₄, LiMnO₂, LiCo_{0.5}Ni_{0.5}O₂, LiNi_{0.7}Co_{0.2}Mn_{0.1}O₂, and the like, and metal oxides not containing lithium, for example, MnO₂, and the like, can be illustrated. In addition to the materials described above, if the material is electrochemically capable of occluding and releasing lithium, the material for the positive electrode is not limited.

### DESCRIPTION OF PREFERRED EMBODIMENTS

Embodiments of the present invention are explained in detail below. It is of course understood that the present invention is not limited to these embodiments and can be modified within the spirit and scope of the appended claims.

### Experiment 1

### Preparation of Negative Electrode

Silicon powder (purity 99.9%, active material a1) having a mean diameter of primary particles of 270 nm (0.27 μm) as an active material was put in a mortar, and the agglomerated structure of the secondary particles was broken apart into primary particles by a pestle.

81.8 weight parts of the silicon powder (active material a1) was added to 8.6 weight % of N-methyl-2-pyrrolidone solution containing 18.2 weight parts of polyimide as a binder and the components were mixed and kneaded by a pestle in a mortar to prepare a slurry.

The slurry was coated on one surface of an electrolytic copper foil (thickness: 35 μm) having a surface roughness (Ra) of 0.5 μm which is a current collector, and was rolled after drying. A disc having a diameter of 20 mm was cut out from the coated copper foil, and was sintered by heating at 400° C. for 30 hours under an argon atmosphere to prepare a negative electrode. The thickness of the electrode (including the current collector) was 50 μm. Therefore, the thickness of the active material layer was 15 μm. Thickness of the active material layer (X)/surface roughness of the copper foil (Ra) was 30. Thickness of the active material layer (X)/thickness of the copper foil (Y) was 0.43.

In the negative electrode, the density of the polyimide was 1.1 g/cm³, and the volume of polyimide was 31.8% based on the total volume of the active material layer including polyimide.

### Preparation of Positive Electrode

Li₂CO₃ and CoCO₃ were weighed such that an atomic ratio of Li and Co atoms, Li:Co, was brought to 1:1 and were mixed in a mortar. The mixture was pressed in a mold having a diameter of 17 mm, and was sintered at 800° C. for 24 hours in air to obtain a sintered LiCoO₂. It was ground in a mortar to particles having a mean diameter of 20 μm.

90 parts by weight of the LiCoO₂ powder and 5 parts by weight of artificial carbon powder as a electrically conductive agent were mixed with 5 weight % of N-methyl-2-pyrrolidone solution containing 5 parts by weight of polyfluorovinylidene as a binder to prepare a positive electrode mixture slurry.

The slurry was coated on aluminum foil which was a current collector, and was rolled after drying. A disc having a diameter of 20 mm was cut out from the coated aluminum foil to prepare a positive electrode.

### Preparation of Electrolyte

1 mol/l LiPF₆ was dissolved in an equal volume mixture (1:1) of ethylene carbonate and diethylene carbonate to prepare an electrolyte.

### Preparation of Battery

A flat (coin) shape lithium secondary battery (A1) was prepared using the positive electrode, the negative electrode and the electrolyte prepared above.

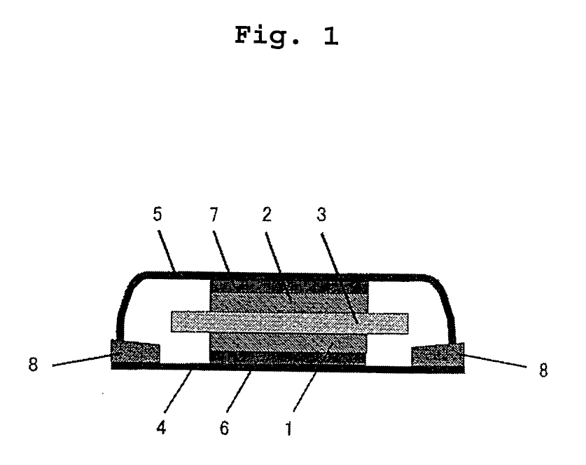

The battery, as shown in FIG. 1, comprises positive electrode 1, negative electrode 2, separator 3, positive electrode can 4, negative electrode can 5, positive electrode current collector 6, negative electrode current collector 7 and insulation packing 8 comprising polypropylene.

The positive electrode 1 and the negative electrode 2 are made to face each other through the separator 3. They are housed in a battery case comprising the positive electrode can 4 and the negative electrode can 5. The positive electrode 1 is connected to the positive electrode can 4 through the positive electrode current collector 6, and the negative electrode 2 is connected to the negative electrode can 5 through the negative electrode current collector 7 to provide a structure capable of being charged and discharged as a secondary battery.

### Experiment 2

Battery A2 was prepared in the same manner as Experiment 1 except that silicon powder (active material a2) having a mean particle diameter of primary particles of 0.8 μm was used in place of the active material a1.

Battery B1 was prepared in the same manner as Experiment 1 except that silicon powder (active material b1) having a mean particle diameter of primary particles of 1.5 μm was used in place of the active material a1.

Battery B2 was prepared in the same manner as Experiment 1 except that the active material was mixed in the binder solution by an agitator instead of breaking apart the active material and mixing the slurry in the mortar.

### Observation of Active Material Particles in Active Material Layer

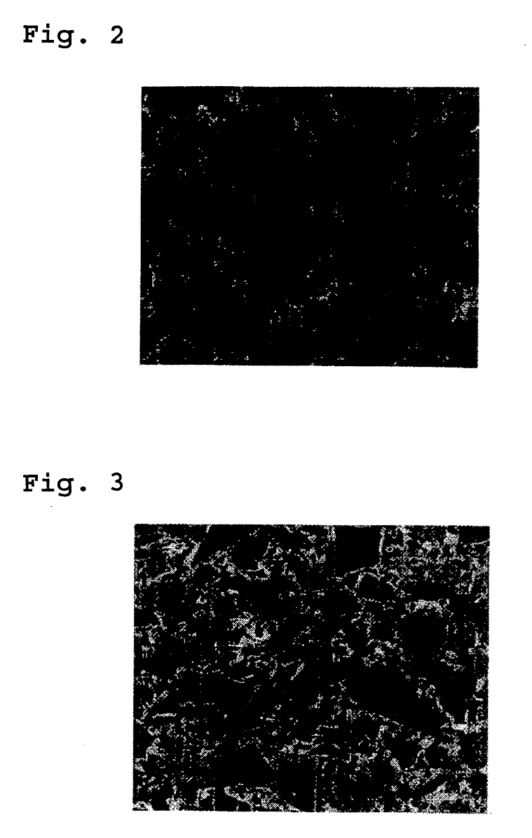

Sections of the active material layers of the negative electrodes of batteries A1 and B2 were observed by a scanning ion microscope (SIM). FIG. 2 is a section of the active material layer of the negative electrode of battery A1. FIG. 3. is a section of the active material layer of the negative electrode of battery B2.

As is clear from FIGS. 2 and 3, there are many apertures in the electrode of battery B2, but there are only a little number of apertures in the electrode of battery A1. The active material of the electrode of battery B2 aggregates and forms secondary particles. It is believed that the apertures were formed around primary particles of the active material because the active material was mixed in the binder solution at a condition of formed secondary particles.

Primary particles of the active material of battery A1 were evenly dispersed and were evenly surrounded by the binder. It is believed that the electrode had a structure that the active material and binder are closely filled in the active material layer.

Charge and discharge cycle characteristics of batteries A1, A2, B1 and B2 were evaluated. Each battery was charged to 4.2 V at a constant current of 1 mA and 25° C., and then was discharged to 2.7 V at a constant current of 1 mA and 25° C. (this is considered to be one charge and discharge cycle). The number of cycles to reach 80% of the discharge capacity of the first cycle was measured to determine a cycle life of the battery. The results are shown in Table 1. The cycle life of each battery is shown as an index when the cycle life of the battery A1 is 100.

TABLE 1

| | Active Material | Method of | |
|---|---|---|---|
| | (Mean Diameter of | preparation of | |
| Battery | Particle) | Slurry | Cycle Life |
| A1 | a1 | Breaking apart + Mixing & | 100 |
| | (0.27 μm) | Kneading | |
| A2 | a2 | Breaking apart + Mixing & | 93 |
| | (0.8 μm) | Kneading | |
| B1 | b1 | Breaking apart + Mixing & | 57 |
| | (1.5 μm) | Kneading | |
| B2 | a1 | Mixing | 12 |
| | (0.27 μm) | | |

As is clear from the results in Table 1, battery A1 prepared by the silicon powder (active material a1) in which the mean diameter of the primary particles is 270 nm (0.27 μm) and battery A2 prepared by the silicon powder (active material a2) in which the mean diameter of the primary particles is 0.8 μm have longer cycle lives compare to battery B1 prepared by the silicon powder (active material b1) in which the mean diameter of the primary particles is 1˜5 μm.

Battery A1 in which the active material was dispersed as primary particles in the binder solution after cohesion of the active material was broken when the slurry was prepared has a longer cycle life as compared to battery B2 in which the slurry was prepared by mixing and stirring.

It is understood that charge and discharge cycle characteristics can be improved when an active material having a mean diameter of primary particles of less than 1 μm is used and is broken apart to form the primary particles and mixed with a binder solution and uniformly dispersed in the solution to form an active material layer. It is believed that the binder uniformly surrounds the primary particles to reinforce the strength of the electrode and to prevent deterioration of the active material layer by expansion and shrinkage of the volume of the active material which accompanies occluding and releasing of lithium during the charge and discharge reactions.

### Experiment 3

The effect of surface roughness (Ra) of the current collector was evaluated.

Batteries A3 and A4 were prepared in the same manner as Experiment 1 except that an electrolytic copper foil having a surface roughness (Ra) of 0.2 μm and 0.17 μm, respectively, was used instead of the electrolytic copper foil having a surface roughness (Ra) of 0.5 μm.

Cycle characteristics of batteries A3 and A4 were evaluated in the same manner described above. Cycle life is described as an index when the cycle life of battery A1 is taken as 100. Table 2 also includes the cycle life of battery A1.

TABLE 2

| | Roughness of Surface | |
|---|---|---|
| | of Current Collector | |
| Battery | (μm) | Cycle Life |
| A1 | 0.5 | 100 |
| A3 | 0.2 | 78 |
| A4 | 0.17 | 66 |

As is clear from the results shown in Table 2, batteries A1 and A3 prepared using a current collector having a surface roughness (Ra) of at least 0.2 μm have excellent cycle characteristics as compared to battery A4 prepared using a current collector having a surface roughness (Ra) of smaller than 0.2 μm. It is believed that the contact area of the particles of the active material and the surface of the current collector is increased by using a metal foil having a surface roughness (Ra) of at least 0.2 μm, and that sintering effectively increases adhesion of the particles of the active material and the current collector, and the binder penetrates into uneven portions of the surface of the current collector, and the adhesion increases because of an anchor effect occurring in the binder and the current collector to increase current collectability of the electrode.

### Experiment 4

The effect of sintering conditions of the electrodes on cycle characteristics was evaluated. Battery A5 was prepared in the same manner as Experiment 1 except that the electrode was treated at 600° C. for ten hours. Battery B3 was prepared in the same manner as Experiment 1 except that the electrode was not treated by heat.

Cycle characteristics of batteries A5 and B3 were evaluated in the same manner as described above. Cycle life is described as an index when the cycle life of battery A1 is taken as 100. Table 3 also includes the cycle life of battery A1.

TABLE 3

| | Heat Treatment | |
|---|---|---|
| Battery | Condition of Electrode | Cycle Life |
| A1 | 400° C., 30 hrs | 100 |
| A5 | 600° C., 10 hrs | 64 |
| B3 | None | 19 |

As is clear from the results shown in Table 3, battery A1 has excellent cycle characteristics as compared to battery B3 prepared without heat treatment of the electrode. It is believed that the particles of the active material and the current collector were sintered by heat treatment, and adhesion of the active material layer and current collector increased to improve the current collectability of the electrode.

Battery A5 in which the electrode is treated at 600° C. for ten hours reduced the cycle characteristics as compared to battery A1 in which the electrode is treated at 400° C. for 30 hours. It appears that the binder was decomposed by the heat treatment at 600° C., and adhesion resulting from the binder in the electrode was significantly reduced to decrease the current collectability.

### Experiment 5

The effect of an electrically conductive powder added to the active material layer on cycle characteristics was evaluated.

Battery A6 was prepared in the same manner as Experiment 1 except that 20 weight % (based on the weight of the copper powder and the silicon powder) of copper powder of a mean diameter of 3 μm was added to the silicon powder. Cycle characteristics of battery A6 were evaluated in the same manner as described above. Cycle life is described as an index when the cycle life of battery A1 is taken as 100. Table 4 also includes the cycle life of battery A1.

TABLE 4

| | Added Electrically | |
|---|---|---|
| Battery | Conductive Powder | Cycle Life |
| A1 | None | 100 |
| A6 | Copper Powder | 102 |

As is clear from the results shown in Table 4, battery A6 in which copper powder is added to the active material had better cycle characteristics than battery A1 which did not include electrically conductive powder in the active material. The electrically conductive powder is believed to have formed a network around the particles of active material to improve the current collectability in the active material layer.

### ADVANTAGES OF THE INVENTION

The present invention improves current collectability of an electrode, and provides a lithium secondary battery having excellent charge and discharge cycle characteristics.

What is claimed is:

1. A negative electrode for a lithium secondary battery prepared by forming an active material layer comprising active material particles of silicon and/or a silicon alloy and a binder on a current collector comprising an electrically conductive metal foil, and sintering the active material layer on the current collector under a non-oxidizing atmosphere, wherein said active material particles are primary particles having a mean diameter of not greater than 1 μm, the primary particles are dispersed uniformly in the active material layer, and the primary particles and the binder are uniformly mixed and distributed.

2. The negative electrode according to claim 1, wherein the active material is silicon.

3. The negative electrode according to claim 1, wherein a surface roughness (Ra) of a surface of the current collector is at least 0.2 μm.

4. The negative electrode according to claim 2, wherein a surface roughness (Ra) of a surface of the current collector is at least 0.2 μm.

5. The negative electrode according to claim 1, wherein the current collector is a copper foil, a copper alloy foil or a metal foil having a copper layer or a copper alloy layer on a surface thereof.

6. The negative electrode according to claim 1, wherein the current collector is an electrolytic copper foil, an electrolytic copper alloy foil or a metal foil having an electrolytic copper layer or an electrolytic copper alloy layer on a surface thereof.

7. The negative electrode according to claim 1, wherein the binder remains after sintering.

8. The negative electrode according to claim 1, wherein the binder is polyimide.

9. The negative electrode according to claim 1, wherein an electrically-conductive powder is mixed in the active material layer.

10. The negative electrode according to claim 1, wherein the active material is silicon, a surface roughness (Ra) of a surface of the current collector is at least 0.2 μm, the current collector is an electrolytic copper foil, an electrolytic copper alloy foil or a metal foil having an electrolytic copper layer or an electrolytic copper alloy layer on the surface, the binder remains after sintering, and the binder is polyimide.

11. A method for preparing a negative electrode for a lithium secondary battery comprising
preparing a slurry comprising an active material in a binder solution, wherein the active material comprises silicon and/or a silicon alloy having an average diameter of primary particles of less than 1 μm and which is broken apart into the primary particles in the binder solution;
coating the slurry on a current collector comprising a metal foil to form an active material layer; and
sintering the active material layer on the current collector under a non-oxidizing atmosphere.

12. The method for preparing a negative electrode according to claim 11, wherein sintering is performed under conditions such that the binder remains after heat treatment.

13. The method for preparing a negative electrode according to claim 11, wherein the active material layer is press rolled together with the current collector before sintering.

14. The method for preparing a negative electrode according to claim 12, wherein the active material layer is press rolled together with the current collector before sintering.

15. A lithium secondary battery comprising: a negative electrode according to any one of claims 1 to 10, a positive electrode comprising a positive electrode active material, and a nonaqueous electrolyte.

16. A lithium secondary battery comprising: a negative electrode prepared by a method according to any one of claims 11 to 14, a positive electrode comprising a positive electrode active material, and a nonaqueous electrolyte.
